(19) United States
(12) Patent Application Publication
(10) Pub. No.: US 2013/0320694 A1
(43) Pub. Date: Dec. 5, 2013

(54) INTEGRATED CARGO AREA CONTAINER SYSTEM

(71) Applicants: Kevin D. Dinger, West Bloomfield, MI (US); Kevin C. Barrett, Richmond, MI (US); Thomas E. Houck, Bloomfield Hills, MI (US); David R. Fischer, Bloomfield Hills, MI (US); John Deak, Weston (CA); Antoine Desjardins, Mississauga (CA); Nick Donatelli, Tottenham (CA); Vladimir Korobchevsky, Thornhill (CA); Vladimir Nikolic, Etobicoke (CA); Kulbir Singh Dhillon, Caledon (CA)

(72) Inventors: Kevin D. Dinger, West Bloomfield, MI (US); Kevin C. Barrett, Richmond, MI (US); Thomas E. Houck, Bloomfield Hills, MI (US); David R. Fischer, Bloomfield Hills, MI (US); John Deak, Weston (CA); Antoine Desjardins, Mississauga (CA); Nick Donatelli, Tottenham (CA); Vladimir Korobchevsky, Thornhill (CA); Vladimir Nikolic, Etobicoke (CA); Kulbir Singh Dhillon, Caledon (CA)

(73) Assignees: ABC GROUP, INC., Toronto (CA); GM GLOBAL TECHNOLOGY OPERATIONS LLC, Detroit, MI (US)

(21) Appl. No.: 13/488,488

(22) Filed: Jun. 5, 2012

(51) Int. Cl. B60R 7/00; B60R 13/02

(52) U.S. Cl. 296/37.16; 296/1.08

(57) ABSTRACT

A vehicle includes a body defining an interior space, and a plurality of trim panels coupled to the body within the interior space of the body and cooperating to define a cargo area therebetween. A collapsible container system is integrated into the plurality of trim panels within the cargo area. The collapsible container system is collapsible into a stowed position disposed between a first one of the plurality of trim panels and the body to conceal the collapsible storage system when not required for storing objects, and is expandable into a storage position extending at least partially across the cargo area to present at least one storage vessel for receiving and storing an object therein.

### TECHNICAL FIELD

The invention generally relates to a vehicle having an interior cargo area, and more specifically to an integrated collapsible container system for securing objects within the cargo area of the vehicle.

### BACKGROUND

Vehicles may include a rear cargo area that is generally defined by various trim panels attached to a body of the vehicle. The cargo area may be the rear portion of a van or a Sport Utility Vehicle (SUV), or the trunk of a sedan. For example, if the vehicle is an SUV, then the cargo area may be defined by an interior roof panel above, a floor surface below, sidewall panels on opposing lateral sides of the cargo area, a liftgate at the rear of the vehicle, and a backrest of a rear passenger seat. Objects placed in the cargo area are generally free to move or slide around within the cargo area, and are not restrained and/or secured except for the features of the vehicle described above that define the cargo area.

### SUMMARY

A vehicle is provided. The vehicle includes a body defining an interior space, and a plurality of trim panels coupled to the body within the interior space of the body. The plurality of trim panels cooperates to define a cargo area. A collapsible container system is integrated into the plurality of trim panels within the cargo area. The collapsible container system is collapsible into a stowed position disposed between a first one of the plurality of trim panels and the body, and is expandable into a storage position extending at least partially across the cargo area to present at least one storage vessel for receiving an object therein.

An interior panel system for a vehicle is also provided. The interior panel system includes a plurality of trim panels cooperating to define a cargo area therebetween. A collapsible container system is integrated into the plurality of trim panels. The collapsible container system is collapsible into a stowed position for disposition between a first one of the plurality of trim panels and a body of the vehicle, and is expandable into a storage position extending at least partially across the cargo area between opposing lateral sides of the cargo area to present at least one storage vessel for receiving an object therein. The first one of the plurality of trim panels includes a fastening mechanism that is configured for fastening the first one of the plurality of trim panels to an adjoining one of the plurality of trim panels when the collapsible container system is disposed in the stowed position. The first one of the plurality of trim panels further includes at least one attachment mechanism that is configured for attaching the first one of the plurality of trim panels to a second one of the plurality of trim panels disposed opposite the first one of the plurality of trim panels across the cargo area to secure the collapsible container system in the storage position.

Accordingly, the collapsible container system may be positioned in the storage position to provide the storage vessels to store objects, thereby preventing the objects from moving around the cargo area. When not required for storage, the collapsible container system may be folded up and positioned in the stowed position, behind one of the trim panels defining the cargo area, thereby concealing the collapsible container system out of sight and providing unfettered access to the cargo area.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle showing a cargo area with a collapsible container system concealed in a stowed position.

FIG. 2 is a schematic cross sectional view of the vehicle showing the collapsible container system in the stowed position.

FIG. 3 a schematic perspective view of the vehicle showing the collapsible container system expanded into a storage position.

FIG. 4 is a schematic cross sectional view of the vehicle showing the collapsible container system in the storage position.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, a vehicle is generally shown at 20. The vehicle 20 may include but is not limited to a Sport Utility Vehicle (SUV), a van or a sedan. The vehicle 20 includes a body 22 that defines the exterior of the vehicle 20 and an interior space 24. An interior panel system 26 is disposed within the interior space 24 of the body 22, and includes a plurality of trim panels 27 that are coupled to the body 22. The trim panels 27 cooperate together to form an interior surface of the vehicle 20 that forms the boundary of a cargo area 29. For example, the interior panel system 26 may include but is not limited to side panels, a overhead roof panel, a door panel, etc. The cargo area 29 may include but is not limited to a rearward area of an SUV or a van, or a trunk of a sedan.

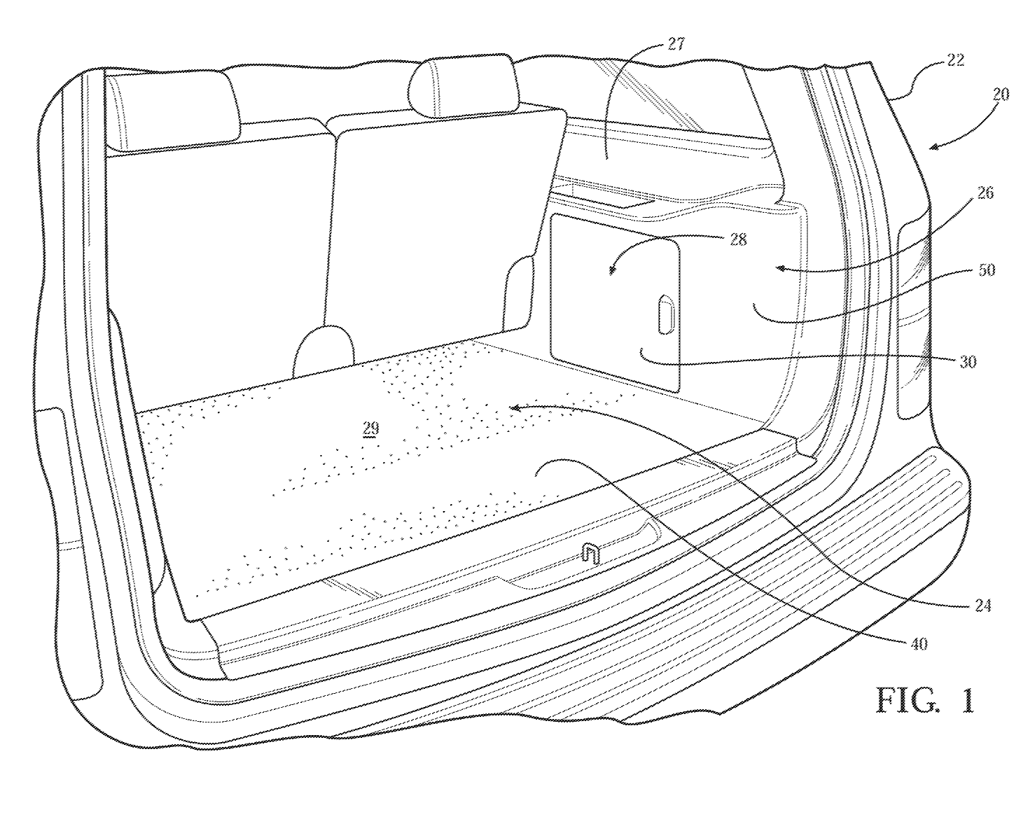

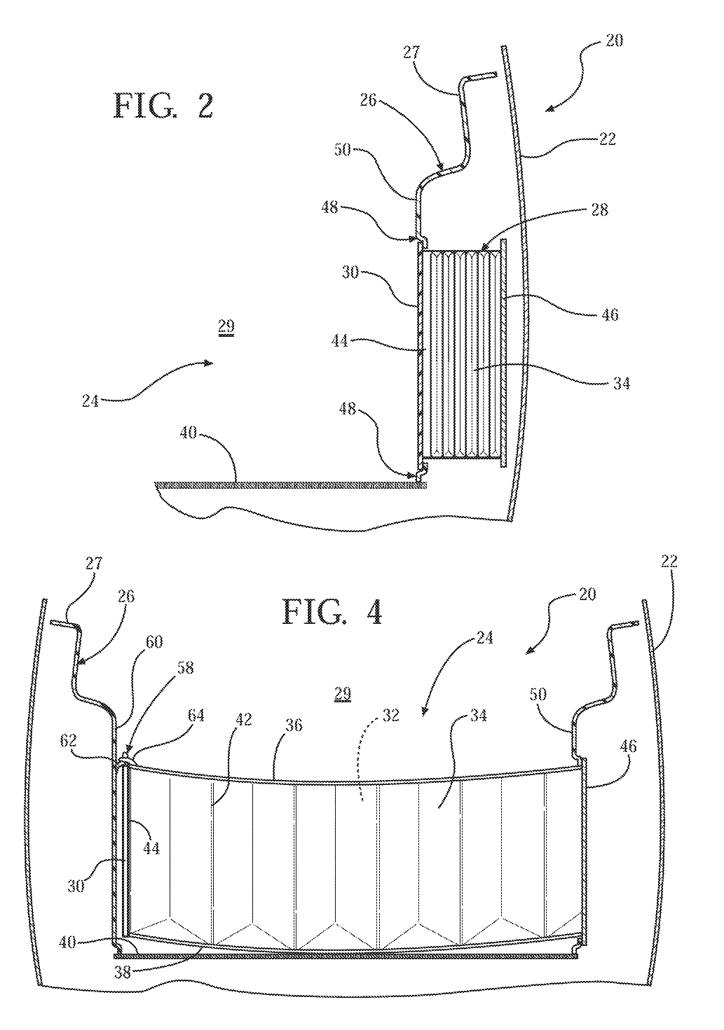

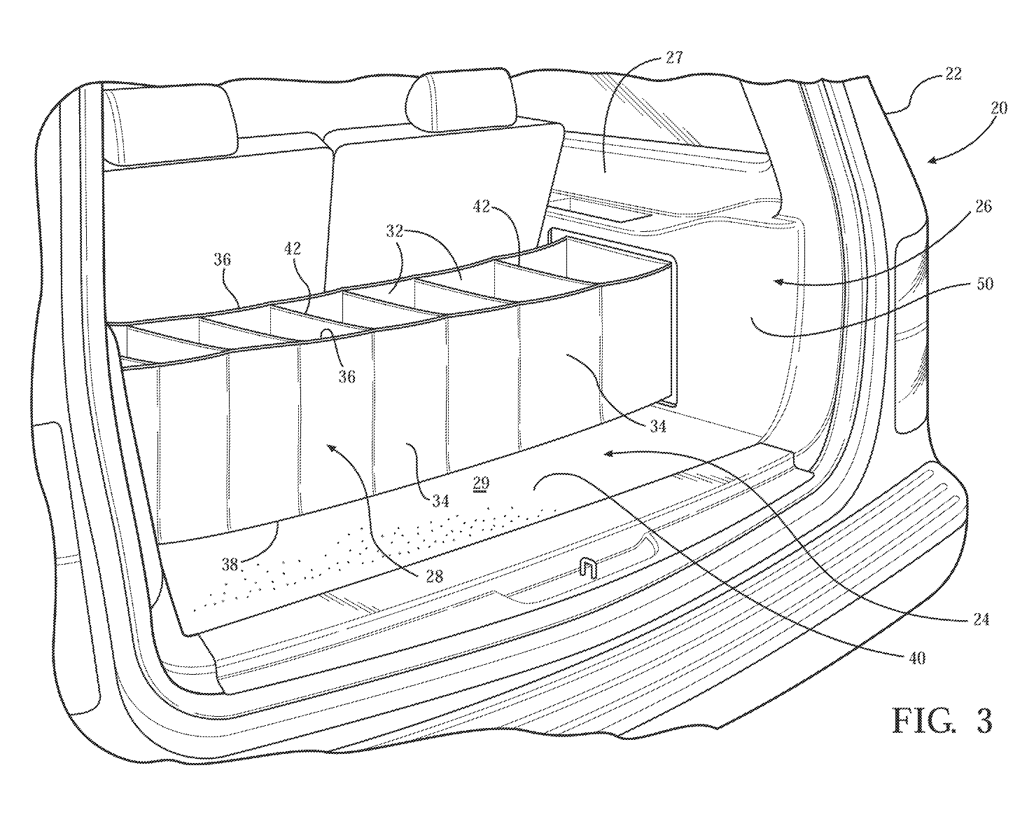

The vehicle 20 includes a collapsible container system 28, which is integrated into the trim panels 27 within the cargo area 29. The collapsible container system 28 folds-in, i.e., contracts, or folds-out, i.e., expands in an accordion-like manner between a stowed position, shown in FIGS. 1 and 2, and an expanded storage position, shown in FIGS. 3 and 4. The collapsible container system 28 collapses into the stowed position disposed between a first one of the trim panels, hereinafter referred to as the first trim panel 30, and the body 22 for storage when not in use. When in the stowed position between the first trim panel 30 and the body 22, the collapsible container system 28 is concealed from sight and out of the way by the interior panel system 26. The collapsible container system 28 expands into the storage position to extend at least partially across the cargo area 29. When in the storage position, the collapsible container system 28 is supported by opposing lateral sides of the cargo area 29 by the interior panel system 26, and presents at least one storage vessel 32 for receiving an object therein.

The collapsible container system 28 includes a flexible exterior 34 that allows the collapsible container system 28 to expand and contract. The flexible exterior 34 defines opposing lateral side walls 36 and a bottom wall 38. The opposing lateral side walls 36 extend across the cargo area 29, with the bottom wall 38 extending between the opposing lateral side walls 36. The bottom wall 38 of the flexible exterior 34 rests upon and is supported by a floor 40 of the cargo area 29 when disposed in the storage position. Preferably and as shown, the collapsible container system 28 includes at least one divider 42 disposed vertically and extending between the opposing lateral side walls 36 to define a plurality of segregated storage vessels 32. The container system may include any number of dividers 42 to form any number of storage vessels 32. Furthermore, the dividers 42 may be arranged to define storage vessels 32 of different sizes.

As shown, the collapsible container system 28 is configured to expand and contract across a width of the vehicle 20, i.e., approximately perpendicular to a longitudinal axis of the vehicle 20, such that the opposing lateral side walls 36 also extend across the width of the vehicle 20. However, it should be appreciated that the collapsible container system 28 may be configured differently than shown and described herein to expand and contract along or parallel to the longitudinal axis of the vehicle 20.

As best shown in FIG. 2, the collapsible container system 28, and more specifically a first end 44 of the flexible exterior 34, is attached to the first trim panel 30. The first end 44 may be attached to the first trim panel 30 with a hook and loop type attachment system, by an adhesive bond, through mechanically interlocking features, or by some other manner that secures the flexible exterior 34 of the collapsible container system 28 to the first trim panel 30. A second end 46 of the flexible exterior 34 is attached to the body 22 and/or one of the trim panels 27 in such a way so that when the first trim panel 30 is removed from the stowed position, the first end 44 of the flexible exterior 34 travels with the first trim panel 30, and the second end 46 of the flexible exterior 34 remains in place. Similar to the first end 44 of the flexible exterior 34, the second end 46 of the flexible exterior 34 may be attached to the body 22 and/or one of the trim panels 27 in any suitable manner, such as with, but not limited to, a hook and loop fastener, mechanically interlocking features, or an adhesive bond.

As shown in FIG. 2, the first trim panel 30 includes a fastening mechanism 48 that fastens the first trim panel 30 to an adjoining one of the plurality of trim panels, hereinafter referred to as the adjoining trim panel 50, when the collapsible container system 28 is disposed in the stowed position. The fastening mechanism 48 may be configured in any manner suitable to releasably attach the first trim panel 30 to the adjoining trim panel 50 when the first trim panel 30 and the collapsible container system 28 are disposed in the stowed position. For example, the fastening mechanism 48 may include but is not limited to a latch having an arm that is rotatable to engage a back side of the adjoining trim panel 50. Alternatively, the fastening mechanism may include a hook and loop type fastening system. It should be appreciated that the fastening mechanism 48 may include a plurality of devices spaced across the first trim panel 30 to secure the entire periphery of the first trim panel 30 relative to all adjoining trim panels 50.

Referring to FIG. 4, the first trim panel 30 may further include at least one attachment mechanism 58 that attaches the first trim panel 30 to a second one of the plurality of trim panels, hereinafter referred to as the second trim panel 60. The second trim panel 60 is disposed opposite the first trim panel 30 across the cargo area 29. The attachment mechanism 58 attaches the first trim panel 30 relative to the second trim panel 60 to secure the collapsible container system 28 in the expanded storage position. The attachment mechanism 58 may be configured in any manner suitable to releasably attach the first trim panel 30 to the second trim panel 60 when the first trim panel 30 and the collapsible container system 28 are disposed in the storage position. For example, referring to FIG. 4, the attachment mechanism 58 may include but is not limited to a detent 62 disposed on the first trim panel 30 and configured for interlocking engagement with an aperture 64 defined by the second trim panel 60. It should be appreciated that the attachment mechanism 58 may include a plurality of devices spaced across the first trim panel 30 and/or the second trim panel 60 to secure the entire periphery of the first trim panel 30 relative to the second trim panel 60. Alternatively, the second trim panel 60 may be removed from position adjacent one or more other trim panels 27, with the first trim panel 30 configured to fit within the void left by the removal of the second trim panel 60 and with the attachment mechanism 58 configured to secure the first trim panel 30 to the trim panels 27 adjacent the second trim panel 60.

The detailed description and the drawings or figures are supportive and descriptive of the invention, but the scope of the invention is defined solely by the claims.

While some of the best modes and other embodiments for carrying out the claimed invention have been described in detail, various alternative designs and embodiments exist for practicing the invention defined in the appended claims.

1. A vehicle comprising:
a body defining an interior space;
a plurality of trim panels coupled to the body, disposed within the interior space of the body, and cooperating to define a cargo area;
a collapsible container system integrated into the plurality of trim panels within the cargo area;
wherein the collapsible container system is collapsible into a stowed position disposed between a first one of the plurality of trim panels and the body, and
wherein the collapsible container system is expandable into a storage position extending at least partially across the cargo area to present at least one storage vessel for receiving an object therein.

2. A vehicle as set forth in claim 1 wherein the first one of the plurality of trim panels includes a fastening mechanism configured for fastening the first one of the plurality of trim panels to an adjoining one of the plurality of trim panels when the collapsible container system is disposed in the stowed position.

3. A vehicle as set forth in claim 2 wherein the fastening mechanism includes a latch having an arm rotatable to engage a back side of the adjoining one of the plurality of trim panels.

4. A vehicle as set forth in claim 2 wherein the collapsible container system is attached to the first one of the plurality of trim panels.

5. A vehicle as set forth in claim 4 wherein the first one of the plurality of trim panels includes at least one attachment mechanism configured for attaching the first one of the plurality of trim panels to a second one of the plurality of trim panels disposed opposite the first one of the plurality of trim panels across the cargo area to secure the collapsible container system in the expanded storage position.

6. A vehicle as set forth in claim 5 wherein the attachment mechanism includes a detent configured for interlocking engagement with an aperture defined by the second one of the plurality of trim panels.

7. A vehicle as set forth in claim 1 wherein the collapsible container system includes a flexible exterior defining opposing lateral side walls and a bottom wall extending between the opposing lateral side walls.

8. A vehicle as set forth in claim 7 wherein the bottom wall of the flexible exterior is supported by a floor of the cargo area when disposed in the storage position.

9. A vehicle as set forth in claim 7 wherein the collapsible container system includes at least one divider extending between the opposing lateral side walls to define a plurality of storage vessels.

10. A vehicle as set forth in claim 7 wherein the collapsible container system is supported by opposing lateral sides of the cargo area by the plurality of trim panels when disposed in the storage position.

11. A vehicle as set forth in claim 1 wherein the collapsible container system contracts and expands in an accordion manner between the stowed position and the storage position.

12. A vehicle as set forth in claim 1 wherein the collapsible container system is concealed by the plurality of trim panels when disposed in the stowed position.

13. An interior panel system for a vehicle, the interior panel system comprising:
a plurality of trim panels cooperating to define a cargo area therebetween;
a collapsible container system integrated into the plurality of trim panels;
wherein the collapsible container system is collapsible into a stowed position for disposition between a first one of the plurality of trim panels and a body of the vehicle;
wherein the collapsible container system is expandable into a storage position extending at least partially across the cargo area between opposing lateral sides of the cargo area to present at least one storage vessel for receiving an object therein;
wherein the first one of the plurality of trim panels includes a fastening mechanism configured for fastening the first one of the plurality of trim panels to an adjoining one of the plurality of trim panels when the collapsible container system is disposed in the stowed position; and
wherein the first one of the plurality of trim panels includes at least one attachment mechanism configured for attaching the first one of the plurality of trim panels to a second one of the plurality of trim panels disposed opposite the first one of the plurality of trim panels across the cargo area to secure the collapsible container system in the expanded storage position.

14. An interior panel system as set forth in claim 13 wherein the fastening mechanism includes a latch having an arm rotatable to engage a back side of the adjoining one of the plurality of trim panels.

15. An interior panel system as set forth in claim 13 wherein the attachment mechanism includes a detent configured for interlocking engagement with an aperture defined by the second one of the plurality of trim panels.

16. An interior panel system as set forth in claim 13 wherein the collapsible container system includes a flexible exterior defining opposing lateral side walls and a bottom wall extending between the opposing lateral side walls.

17. An interior panel system as set forth in claim 16 wherein the bottom wall of the flexible exterior is supported by a floor of the cargo area when disposed in the storage position.

18. An interior panel system as set forth in claim 16 wherein the collapsible container system includes at least one divider extending between the opposing lateral side walls to define a plurality of storage vessels.

19. An interior panel system as set forth in claim 13 wherein the collapsible container system is supported by opposing lateral sides of the cargo area by the plurality of trim panels.

20. An interior panel system as set forth in claim 13 wherein the collapsible container system folds in an accordion manner between the stowed position and the storage position.
